(19) United States
(12) Patent Application Publication
(10) Pub. No.: US 2026/0029124 A1
(43) Pub. Date: Jan. 29, 2026

(54) METHOD FOR THE AUTOGENOUS PROCESSING OF METALS

(71) Applicants: Messer SE & Co. KGaA, Bad Soden (DE); Messer Cutting Systems GmbH, Groß-Umstadt (DE)

(72) Inventors: Jürgen Eitel, Fränkisch-Crumbach (DE); Bernd Hildebrandt, Tönisvorst (DE)

(73) Assignees: Messer SE & Co. KGaA, Bad Soden (DE); Messer Cutting Systems GmbH, Groß-Umstadt (DE)

(21) Appl. No.: 18/998,179

(22) PCT Filed: Jul. 6, 2023
(86) PCT No.: PCT/EP2023/068791

§ 371 Date: Jan. 24, 2025

(30) Foreign Application Priority Data
Jul. 25, 2022 (DE) 10 2022 118 585.0

(51) Int. Cl. F23D 14/32; B23K 5/213; F23D 14/40

(52) U.S. Cl. CPC F23D 14/32; B23K 5/213; F23D 14/40

(57) ABSTRACT

The invention relates to a method for the autogenous processing of metals, in which a hydrogen as a fuel gas from a fuel gas source and oxygen as an oxidising agent from an oxidising agent source are brought together in a processing tool and a flame used to process a workpiece is generated in front of an opening in the processing tool, characterised in that a combustible carbon-containing additive gas is added to the fuel gas in the processing tool, which is burned together with oxygen in a luminous flame.

The invention relates to a process for autogenous processing of metals where hydrogen from a hydrogen source and oxygen from an oxygen source are combined at a processing tool and reacted with one another to generate a flame used for autogenous processing of a workpiece in front of an aperture opening of the processing tool.

Autogenous flame cutting of metals and other autogenous processing methods, for example flame straightening, gouging or autogenous welding, nowadays predominantly employ fuel gases based on hydrocarbons such as propane, acetylene, propene, ethene, etc., as described for example in DE 2 823 305 A1. Due to the carbon dioxide emissions generated by combustion of these gases, legislation that is already being prepared will in the near future impose a CO₂ tax on precisely these fuel gases and fuel gas mixtures. Irrespective of the cost aspect, the avoidance of climate-harmful carbon dioxide and other emissions, for example carbon monoxide or micro-particulates (carbon) which are formed as reaction products of combustion, has a high priority for enhancing occupational safety and protection of the environment.

A possible alternative to carbon-based fuel gases is hydrogen, a fuel gas that has been known in autogenous technology for over 100 years. However, in autogenous technology the use of hydrogen as fuel gas is associated with the disadvantage that it burns in oxygen with a bluish, transparent flame which is almost invisible especially in relatively bright surroundings. The associated poor observability of the flame impedes or prevents clean adjustment of the primary flame cone and handling to maintain a defined distance between the flame cone(s) and the surface of a workpiece to be processed. In this regard, adjustment of an optimal fuel gas-oxygen mixture is achievable visually only with difficulty, if at all. For manual operations, the satisfactory use of hydrogen as fuel gas is thus possible only in exceptional cases. Automated operation could employ suitable control technology using flowmeters or the like, though this entails additional apparatus complexity which in turn increases susceptibility to failures.

EP 0 952 205 A1 discloses improving the visibility of the hydrogen flame of a cutting torch by employing a fuel gas mixture consisting of hydrogen and acetylene in a ratio of 99:1 to 90:10. The gas mixture is provided in a container or produced directly in a mixing apparatus upstream of the cutting torch. However, the storage or conveying of a gas mixture containing acetylene is not without problems since acetylene is susceptible to explosive autodecomposition.

It is accordingly an object of the present invention to provide an option for using hydrogen as fuel gas in autogenous technology which overcomes the aforementioned disadvantages.

This object is achieved by a process according to claim 1. Advantageous embodiments of the invention are specified in the subsidiary claims.

According to the invention a process for autogenous processing of metals where hydrogen from a hydrogen source and oxygen from an oxygen source are combined at a processing tool and reacted with one another to generate a flame used for autogenous processing of a workpiece downstream of an aperture opening of the processing tool is thus characterized in that in the processing tool upstream of the flame generation the hydrogen is admixed with an additive gas from an additive gas source that burns with oxygen with a visible flame.

According to the invention the hydrogen used as the actual fuel gas for the autogenous processing is admixed with an additive gas only in the processing tool which is for example a cutting torch. Due to the very late supplying of the additive gas it is even possible to employ gases with a tendency for spontaneous autodecomposition, such as acetylene, as additive gas without any risk to a user. The additive gas is likewise flammable and burns with oxygen with a flame that is readily perceptible in the visible spectral range. The combustion processes initiated by the additive gas commixed with the hydrogen result in a good perceptibility of the resulting flame. The parameters important for autogenous processing, for example flame temperature, ignition speed or flame power, are affected by the additive gas only insubstantially or even positively, if at all. The aforementioned disadvantages of using pure hydrogen as fuel gas can therefore be overcome.

The term “hydrogen” is in the present case to be understood as meaning a gas having a hydrogen content of at least 99.5% by volume, preferably of at least 99.99% by volume.

The term “oxygen” is in the present case to be understood as meaning an oxygen-containing gas having an oxygen content of more than 90% by volume, preferably a gas having an oxygen content of more than 99% by volume, especially preferably having an oxygen content of more than 99.9% by volume.

Employed hydrogen sources and oxygen sources include sources customary for autogenous processing methods, in particular a compressed gas cylinder, a compressed gas cylinder bundle or a tank.

The additive gas employed is preferably a carbon-containing gas, such as acetylene, methylacetylene, butyne or butadiene, which is admixed with the hydrogen in a volume flow ratio of 1-50%, preferably 2-10%, particularly preferably 2-3%. An alternative additive gas that may be employed is a phosphorus compound, preferably a gaseous phosphorus-hydrogen compound such as PH3, or a gaseous sulfur compound, such as hydrogen sulfide (H2S). In this case the addition amount of the additive gas in the volume/the volume flow of the hydrogen should be not more than 50 vpm, preferably between 10 vpm and 50 vpm, where even such a low doping is sufficient to produce a readily visible flame. An additive gas in the form of a mixture of two or three of the recited gases is likewise conceivable. Furthermore, in operation of the processing tool the volume flow ratio of the hydrogen and the additive gas should advantageously also be alterable within the aforementioned limits or beyond, for example to be able to realize a greater visibility of the flame that is necessary for a short time.

The additive gas source employed is a container suitable for the corresponding additive gas, for example a pressure container or tank, and in the case of acetylene for example a cylinder or a cylinder bundle approved for storage of acetylene. The processing tool according to the invention is for example a customary tool for autogenous processing, for example an autogenous flame cutting machine, an apparatus for flame spraying, an apparatus for gouging or an autogenous welding apparatus. The process according to the invention is thus especially suitable for all of the aforementioned autogenous processing methods.

The supply of the additive gas to the hydrogen in the processing tool is preferably effected using a suitable mixing valve which is arranged upstream of the supply of the oxygen in the processing tool. For example, a pressure nozzle which effects the incorporation of the additive gas into the hydrogen is provided inside the processing tool and is arranged upstream (in the flow direction of the hydrogen) of a combining of the hydrogen-additive gas mixture with the supplied oxygen. This too may also be a pressure nozzle.

In an advantageous embodiment of the invention the ratio of the volume flows of hydrogen and additive gas and hydrogen-additive gas mixture and oxygen are variably adjustable at the processing tool during use, wherein altering of the volume flow ratio may in each case be effected by altering the volume flow of one component at otherwise constant volume flow of the other component or by respectively altering both volume flows at substantially constant total volume flow. To this end the processing tool is preferably fitted with a mixing valve which allows corresponding adjustment of the volume flows. Adjustment of the volume flows is preferably effected manually but it is also possible to provide, alternatively or in addition, an automatic control which controls the volume flow ratio of the respective components according to a predetermined program and/or according to measured parameters. Contemplated controlled variables include for example a certain flame brightness, a predetermined value or profile for the mixing ratio or a threshold value for a substance in the offgas which is continuously or at predetermined intervals compared to a measured value of the corresponding parameter. In the case of the aforementioned series connection of pressure nozzles these are preferably provided with independently adjustable control means which allow manual or automated adjustment of the volume flow ratios at the respective pressure nozzle.

The freely adjustable nature of the volume flow ratios allows flexible adaptation of the gas inflows to the flame type and/or the particular circumstances under which the autogenous processing is carried out. For example depending on the autogenous process and/or the material to be processed it may be necessary to employ an oxidizing flame (operated with excess oxygen), a reducing flame (operated with excess hydrogen) or a neutral flame. To allow the mixture state to be ascertained a user would need to be able to identify a primary flame cone which, however, is barely visible, if at all, in the case of a pure hydrogen flame. Due to the freely adjustable addition of the additive gas a primary flame cone may also be made clearly visible to a user in the case of different flame types or different other circumstances, for example the light conditions in the working area.

The process according to the invention is suitable for all known autogenous processing methods, for example for autogenous welding, flame cutting, flame straightening or gouging. Furthermore, all materials typically processable with autogenous technology may be processed, especially unalloyed or low-alloyed steels or aluminum materials. The process according to the invention is especially suitable for flame cutting of unalloyed or low-alloyed steels, especially of such steels having a sheet thickness of more than 10 mm.

1. A process for autogenous processing of metals where hydrogen from a hydrogen source and oxygen from an oxygen source are combined at a processing tool and reacted with one another to generate a flame used for autogenous processing of a workpiece downstream of an aperture opening of the processing tool, wherein
in the processing tool upstream of the flame generation the hydrogen is admixed with an additive gas from an additive gas source that burns with oxygen with a visible flame.

2. The process as claimed in claim 1, wherein the ratio of the volume flows of hydrogen and additive gas is variably adjustable at the processing tool during use.

3. The process as claimed in claim 1, wherein the ratio of the volume flows of hydrogen and oxygen is adjustable.

4. The process as claimed in claim 1, wherein the additive gas employed is a carbon-containing gas, such as acetylene, methylacetylene or butadiene.

5. The process as claimed in claim 1, wherein the additive gas employed is a gas comprising a phosphorus and/or a sulfur compound.

6. The process as claimed in claim 4, wherein the carbon-containing gas used as additive gas is admixed with the hydrogen in a proportion of 0.1% by volume to 10% by volume, preferably between 2% by volume and 5% by volume.

7. The process as claimed in claim 1, wherein the autogenous processing of the workpiece consists of welding, flame cutting, flame straightening or gouging.
